(19) United States
(12) Patent Application Publication
(10) Pub. No.: US 2006/0056869 A1
(43) Pub. Date: Mar. 16, 2006

(54) Image forming apparatus

(75) Inventors: Yotaro Sato, Tokyo (JP); Takenobu Kimura, Tokyo (JP); Hiroshi Akita, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/135,496

(22) Filed: May 24, 2005

(30) Foreign Application Priority Data
Sep. 15, 2004 (JP) JP2004-268050

(51) Int. Cl. G03G 15/16

(52) U.S. Cl. 399/66; 399/101; 399/297; 399/302

(57) ABSTRACT

Disclosed is an image forming apparatus that comprises: an image bearing member; an image forming unit for forming a toner image on the image bearing member; an intermediate transfer member; a first transfer device for transferring the toner image on the image bearing member onto the intermediate transfer member; a second transfer device for transferring the toner image on the intermediate transfer member onto a transfer material; an intermediate transfer member cleaner for cleaning the intermediate transfer member after the transfer; a charging unit for giving the electric charge to the intermediate transfer member; and a control unit by which, when the charging unit is controlled, in non-image area on the intermediate transfer member, the intermediate transfer member is charged to the reverse polarity to the charge of toner, and the toner adhered to the second transfer device is transferred to the intermediate transfer member.

### CROSS-REFERENCE TO RELATED APPLICATION

This application is based on Japanese Patent Application No. 2004-268050 filed with Japan Patent Office on

### BACKGROUND OF THE INVENTION

1. Field of the Invention

The present invention relates to an electro-photographic system image forming apparatus which is an image forming apparatus such as a copier, printer, facsimile and a complex apparatus having functions of these apparatus together, and particularly to an image forming apparatus having an intermediate transfer member.

2. Description of the Related Art

In an electro-photographic system image forming process, there is a process by which a toner image is formed on an image bearing member such as a photoreceptor by charging, exposing and developing, the formed toner image is primarily transferred onto an intermediate transfer member, and the toner image on the intermediate transfer member is further secondarily transferred onto a transfer material. Such an image forming process is used often in a color image forming apparatus, and when a monochromatic toner image is formed on a plurality of photoreceptors, and transferred onto the intermediate transfer member, the monochromatic toner images are superposed on the intermediate transfer member, and a multicolored toner image is formed, and the formed multicolored toner image is transferred onto the transfer material.

In the image forming process in which the secondary transfer is conducted by using the intermediate transfer member, there is a problem that the toner is adhered to a second transfer device and the second transfer device is soiled. That is, in a non-image area such as a leading edge, trailing edge, side edge of the transfer material, in a part at which the second transfer device and the intermediate transfer member are directly brought into contact with each other not through the transfer material, the toner slightly adhered to the intermediate transfer member in the non-image area is transferred to the second transfer device, and the second transfer device is soiled. Due to such a soil of the second transfer device, transfer fault is caused and the image quality is lowered, or the toner adhered to the second transfer device is adhered to the rear surface of the transfer material and becomes a rear surface soil, and the quality of printed matter, repro is lowered.

Further, there is a problem that collected toner is accumulated on the intermediate transfer member cleaner, and the cleaning performance is lowered.

Various countermeasures to these problems are proposed. For example, in Japanese Unexamined Laid-Open Patent Publication No. Hei6-51655A, it is disclosed that, when the voltage of the same polarity as the charge of toner is applied onto a transfer roller supporting the transfer material, the toner adhered to the transfer roller is returned to the photoreceptor.

In Japanese Unexamined Laid-Open Patent Publication No. Hei7-128999A, it is disclosed that, when the image bearing member is charged and brought into contact with the transfer roller, the toner is removed from the transfer roller.

In Japanese Unexamined Laid-Open Patent Publication No. Hei8-272235A, it is disclosed that the same polarity voltage as the toner and inverse polarity voltage to the toner, are successively applied onto the transfer member, and the toner on the transfer member is inversely transferred onto the photoreceptor.

Both of countermeasures proposed in the JP Publication Nos. Hei6-51655A and Hei8-272235A are measures by which the toner is removed from the transfer device by the electrostatic force. However, because the potential of material body of the transfer destination, such as the photoreceptor, of the removed toner is not uniform, the strength of the electric field to which the toner is transferred, is not uniform depending on a position, and the toner remains on the transfer device and is not perfectly removed. Further, the technology disclosed in the JP Publication No. Hei7-128999A can not be used for the cleaning of the second transfer device in the image forming apparatus using the intermediate transfer member.

### SUMMARY

The object of the present invention is to solve such a problem in the conventional engineering, that is, a problem of the lowering of the image quality caused by the soil of second transfer device and a problem of poor cleansing.

In order to attain the above object, an image forming apparatus reflected an example of the present invention comprises: an image bearing member; an image forming unit for forming a toner image on the image bearing member; an intermediate transfer member; a first transfer device for transferring the toner image on the image bearing member onto the intermediate transfer member; a second transfer device for transferring the toner image on the intermediate transfer member onto a transfer material; an intermediate transfer member cleaner for cleaning the intermediate transfer member after the transfer; a charging unit for applying an electric charge to the intermediate transfer member; and a control unit, by controlling the charging unit, in a non-image area on the intermediate transfer member, for charging the intermediate transfer member into the reverse polarity to the charge of the toner, and for transferring the toner adhered on the second transfer device to the intermediate transfer member.

Further, the image forming apparatus reflected another example of the present invention comprises: an image bearing member; an image forming unit for forming a toner image on the image bearing member; an intermediate transfer member; a first transfer device for transferring the toner image on the image bearing member onto the intermediate transfer member; a second transfer device for transferring the toner image on the intermediate transfer member onto a transfer material; an intermediate transfer member cleaner for cleaning the intermediate transfer member after the transfer; a charging unit for discharging the intermediate transfer member; and a control unit for controlling the second transfer device and the charging unit, in the non-image area on the intermediate transfer member, so as to discharge the intermediate transfer member by the charging unit, and so as to conduct the inverse-transfer for transferring the toner from the second transfer device to the discharged intermediate transfer member.

Further, the image forming apparatus reflected another example of the present invention comprises: an image bearing member; an image forming unit for forming a toner image on the image bearing member; an intermediate transfer member; a first transfer device for transferring the toner image on the image bearing member onto the intermediate transfer member; a second transfer device having a transfer roller, which can be brought into contact with and separated from the intermediate transfer member, and for transferring the toner image on the intermediate transfer member onto a transfer material; an intermediate transfer member cleaner for cleaning the intermediate transfer member after the transfer; and a charging unit for applying an electric charge to the intermediate transfer member, wherein, when a cleaning width of the intermediate transfer member is H3, a charging width of the charging unit is H2, and a length of the transfer roller is H1, then, H1≦H2≦H3 is satisfied.

Further, the image forming apparatus reflected yet another example of the present invention comprises: an image bearing member; an image forming unit for forming a toner image on the image bearing member; an intermediate transfer member; a first transfer device for transferring the toner image on the image bearing member onto the intermediate transfer member; a second transfer device for transferring the toner image on the intermediate transfer member onto a transfer material; an intermediate transfer member cleaner for cleaning the intermediate transfer member after the transfer; a charging unit for applying an electric charge to the intermediate transfer member; and a control unit for controlling the charging unit so that, when, in the non-image area, the charging unit charges the intermediate transfer member into reverse polarity to the charge of toner, the toner adhered to the intermediate transfer member cleaner is moved to the intermediate transfer member.

Further, the image forming apparatus reflected yet another example of the present invention comprises: an image bearing member; an image forming unit for forming a toner image on the image bearing member; an intermediate transfer member; a first transfer device for transferring the toner image on the image bearing member onto the intermediate transfer member; a second transfer device for transferring the toner image on the intermediate transfer member onto a transfer material; an intermediate transfer member cleaner, having a cleaning member and a power source to apply the voltage on the cleaning member, and for cleaning the intermediate transfer member after the transfer; and a charging unit for applying an electric charge to the intermediate transfer member; and a control unit for controlling the charging unit so that it discharges the intermediate transfer member, and for controlling the power source so that the toner is transferred onto the discharged intermediate transfer member from the cleaning member.

Hereupon, in the present specification, the charging polarity of toner means, basically other than a case where particularly described, the charging polarity of toner forming the toner image.

Further, the image area is an area set by a profile of the transfer material, and the image area of the intermediate transfer member is an area in which the intermediate transfer member is superposed on the transfer material in the second transfer. Then, the non-image area is an area excepting the image area. Accordingly, the non-image area is, in the image forming process, an image gap between the front and rear image areas and a side edge area of the image area, and the entire area on the intermediate transfer member in the process in which the image formation is not conducted, such as the transfer roller cleaning process or cleaner cleaning process which will be described later.

Further, the charging unit is a unit for applying an electric charge to the intermediate transfer member, and for example, when the electric charge is given to the intermediate transfer member having the electric charge, such as the intermediate transfer member bearing the toner image, by the charging unit, depending on a case where the electric charge having the same polarity as that on the intermediate transfer member is applied, or the electric charge of the reverse polarity is applied, the potential on the intermediate transfer member is increased or decreased. Accordingly, depending on the charge by the charging unit, there is also a case where the surface potential of the intermediate transfer member is reversed.

### BRIEF DESCRIPTION OF DRAWINGS

The above described and other objects, advantages and features of the invention will become apparent from the following description thereof taken in conjunction with the accompanying drawings in which:

FIG. 1 is a view showing an entire structure of an image forming apparatus according to the first example of the present invention;

FIG. 2 is a view showing a main part of the image forming apparatus according to the second example of the present invention;

FIG. 3 is a view showing a time chart of a control in the third example of the present invention;

FIG. 4(a) and FIG. 4(b) are views showing a main part of the image forming apparatus according to the fourth example of the present invention; and

FIG. 5 is a view showing a main part of the image forming apparatus according to the fifth, sixth examples of the present invention.

### DETAILED DESCRIPTION OF THE PREFERRED EMBODIMENTS

Hereinbelow, typical embodiments of the present invention will be explained with reference to the drawings. It should be note that the present invention is not limited to the embodiments described below. Definition of terms described below are given by way of explanation of the terms only, and thus the definitions of the terms of the inventions are not limited thereto.

### THE FIRST EXAMPLE

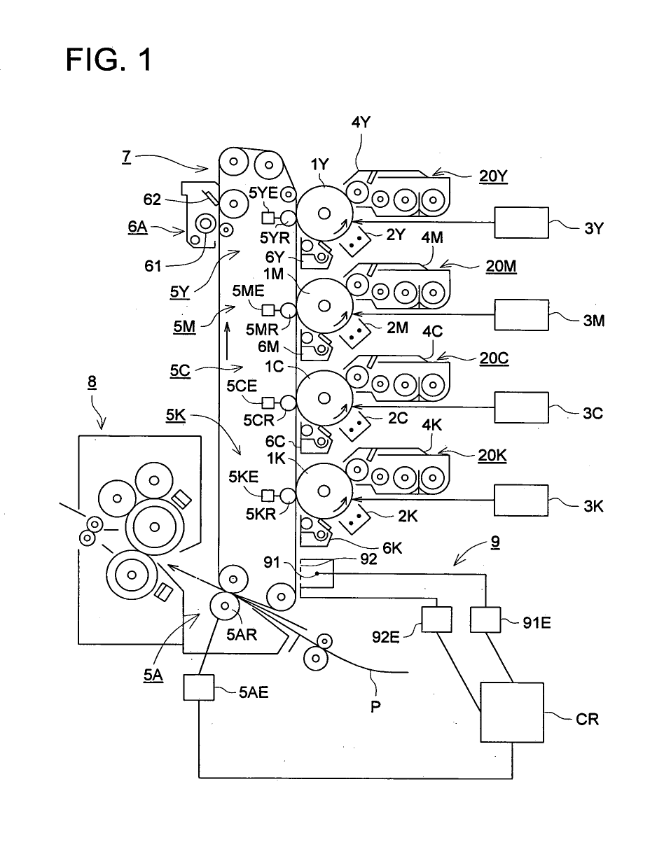

FIG. 1 is a view showing a color image forming apparatus according to the first example of the present invention. This color image forming apparatus is one called a tandem type color image forming apparatus, and has a plurality of sets of image forming units 20Y, 20M, 20C, 20K, an intermediate transfer unit, and a sheet conveying apparatus and a fixing apparatus 24.

The image forming unit 20Y forming yellow image has a charge apparatus 2Y arranged around a photoreceptor 1Y as an image bearing member, exposure apparatus 3Y, developing apparatus 4Y, first transfer device 5Y and cleaner 6Y. The image forming unit 20M forming a magenta image has a charge apparatus 2M arranged around a photoreceptor 1M as an image bearing member, exposure apparatus 3M, developing apparatus 4M, first transfer device 5M and cleaner 6M. The image forming unit 20C forming a cyan image has a charge apparatus 2C arranged around a photoreceptor 1C as an image bearing member, exposure apparatus 3C, developing apparatus 4C, first transfer device 5C and cleaner 6C. The image forming unit 20K forming a black image has a charge apparatus 2K arranged around a photoreceptor 1K as an image bearing member, exposure apparatus 3K, developing apparatus 4K, first transfer device 5K and cleaner 6K.

As photoreceptors 1Y, 1M, 1C, 1K, commonly known photoreceptor such as an OPC photoreceptor or Si photoreceptor is used, however, the OPC photoreceptor is preferable, particularly, a negative charging OPC photoreceptor is preferable, and in the present embodiment, the negative charging OPC photoreceptor is used.

As the charging apparatus 2Y, 2M, 2C, 2K, a corona charging apparatus such as a scorotron, corotron, is used, however, the scorotron charging apparatus is preferably used.

As the exposure apparatus 3Y, 3M, 3C, 3K, a light emitting element which is light emitted according to the image data, such as a laser, LED array, is used.

As the developing apparatus 4Y, 4M, 4C, 4K, a developing apparatus using two-component developing agent in which career and toner are a main component, is used, however, a two-component developing apparatus using a small particle diameter toner is preferable. Further, an developing apparatus which conducts the developing in the regular developing, or which conducts the reversal developing can be used as the developing apparatus, however, the reversal development which applies the developing bias of the same polarity as the charge of the photoreceptor on the developing sleeve, and which conducts the developing by using the toner charged with the same polarity as the charge of the photoreceptor, is preferable, and in the present embodiment, the development is conducted by the reversal development using the negatively charged toner.

As the small particle diameter toner, a toner whose volume average particle diameter is 3-6 μm, is preferable. Further, in the present example, a spherical toner is preferable, and it is preferable that its sphericity is not lower than 0.94, and not higher than 0.98. It is preferable that, for the above-described small diameter and high sphericity toner, polymerization toner is used. The polymerization toner is can be obtained via the polymerization reaction process such as the suspension polymerization or emulsion polymerization, and the fusion process of mutual particles conducted after that at need. The volume average particle diameter is an average particle diameter based on the volume, and a value measured by “Coulter counter TA-11” provided with a wet dispersion device, or “Coulter multi-seizer” (available from Beckman Coulter Inc. (California)).

By such a small particle diameter toner, a high quality image having a high resolving power can be formed. When the toner whose volume average particle diameter is larger than 6 μm, is used, the feature of the high image quality becomes weak when the toner whose volume average particle diameter is smaller than 3 μm, is used, the lowering of the image quality due to fogging, is easily happened.

Further, in the present example, spherical toner is desirable, and it is desirable that its conglobation degree is not smaller than 0.94 and not larger than 0.98. Herein, the conglobation degree is a degree in which “the peripheral length of the circle whose area is the same as the particle projection image” is divided by “the peripheral length of the particle projection image”. The conglobation degree can be calculated when, for 500 resin particles, a photography of the resin particle enlarged to 500 times is photographed by the scanning type electronic microscope or the laser microscope, the photographic image is analyzed by using the image analyzer (Scanning Image Analyzer) (available from JEOL, Ltd., Tokyo, Japan), the circularity is measured, and its arithmetic mean value is obtained. Further, as the simple measuring method, it can be measured by “FPIA-1000” (available from Sysmex Corporation, Kobe, Japan).

When the conglobation degree is smaller than 0.94, from a result that strong stress is received in the developing apparatus, the particle is powdered, a fogging or toner splash is easily generated. Further, when the conglobation degree is larger than 0.98, there is a case where it becomes difficult that the cleaning performance is kept high. For the small particle diameter toner as described above, and high conglobation degree toner, it is desirable that the polymerization toner is used. The polymerization toner means a toner which is formed and obtained by the generation of binder resin for the toner, and by the polymerization of the raw material monomer or pre-polymer in which the toner shape is binder resin, and a toner formed and obtained by the chemical processing after that. More specifically, it means a toner obtained by a polymerization reaction such as the suspension polymerization or emulsion polymerization, and a toner obtained via an adhesion process of mutual particles conducted at need after that. In the polymerization toner, because the toner is manufactured by the polymerization after the raw material monomer or pre-polymer is dispersed uniformly in the water system, the toner whose particular size distribution and shape are uniform is obtained.

Specifically, a toner is produced by the suspension method, or a toner can be manufactured by a method by which a minute size polymerization particle is manufactured by the emulsion polymerization of monomer in the liquid of water-system medium to which the emulsifying liquid is added, and then, the organic solvent, flocculating agent are added and associated. At the time of the association, a method by which it is mixed with a dispersing liquid such as the parting agent or coloring agent necessary for composition of the toner, and prepared, or a method by which, after the toner component such as the parting agent or coloring agent is dispersed in the monomer, it is emulsion-polymerized, is listed. Herein, the association means that a plurality of resin particles and coloring agent particles are fused.

The first transfer device 5Y is provided with a transfer roller 5YR formed of a conductive rubber roller, and a power source 5YE, the first transfer device 5M is provided with a transfer roller 5MR formed of a conductive rubber roller, and a power source 5ME, the first transfer device 5C is provided with a transfer roller 5CR formed of a conductive rubber roller, and a power source 5CYE, and the first transfer device 5K is provided with a transfer roller 5KR formed of a conductive rubber roller, and a power source 5KE.

The intermediate transfer member 7 is semi-conductive, and a belt-like member wound by a plurality of rollers and supported circulation-movably.

By the image forming unit composed of the charging apparatus 2Y, exposure apparatus 3Y and developing apparatus 4Y, the charge, exposure and development are conducted on the photoreceptor 1Y, a yellow toner image is formed on the photoreceptor 1Y. In the same manner, by the image forming unit composed of the charging apparatus 2M, exposure apparatus 3M and developing apparatus 4M, a magenta toner image is formed on the photoreceptor 1M, by the image forming unit composed of the charging apparatus 2C, exposure apparatus 3C and developing apparatus 4C, a cyan toner image is formed on the photoreceptor 1C, and by the image forming unit composed of the charging apparatus 2K, exposure apparatus 3K and developing apparatus 4K, a black toner image is formed on the photoreceptor 1K. These mono chromatic toner images are transferred onto the intermediate transfer member 7 by the transfer rollers 5Y, 5M, 5C, 5K, and superimposed on each other, and a multi-color toner image is formed.

A sign 5A is the second transfer device, and is provided with the transfer roller 5AR formed of a conductive rubber roller, and the power source 5AE.

A sign 6A is the intermediate transfer member cleaner for cleaning the intermediate transfer member 7. The intermediate transfer member cleaner 6A has a cleaning roller 61 and a cleaning blade 62 formed of a rubber blade, as a cleaning member.

Numeral 8 is a fixing apparatus for fixing the toner image on the transfer material P.

Numeral 9 is the charging unit composed of a scorotron charger, and has a charging electrode 91 and a grid 92, and the charge voltage is applied on the charging electrode 91 from a power source 91E, and the voltage is applied on the grid 92 from a power source 92E.

A control unit CR for controlling the whole of the image forming apparatus shown in FIG. 1 conducts the image forming process for forming the image on the transfer material P, and the transfer roller cleaning process for cleaning the transfer roller 5AR.

In the image forming process, for example, as in the manner of the charge by the charging apparatus 2Y, image exposure by the exposure apparatus 3Y, development by the developing apparatus 4Y, and first transfer by the first transfer device 5Y, the charge, image exposure, development and transfer are conducted in respective of the image forming units 20Y, 20M, 20C and 20K, and the toner images formed in each of image forming units 20Y, 20M, 20C, 20K are first-transferred onto the intermediate transfer member 7 and superimposed on each other, and a multi-colored toner image is formed on the intermediate transfer member 7.

In the image forming process, the transfer voltage whose polarity is reverse to the that of toner charge, that is, the positive transfer voltage is respectively applied on the transfer rollers 5YR, 5MR, 5CR, 5KR, by the power sources 5YE, 5ME, 5CE, 5KE, 5AE, and the charging unit 9 charges the intermediate transfer member 7 so that the charge amount of the toner image on the intermediate transfer member 7 is made uniform to a low value. Specifically, in the present embodiment using the negative charge toner, when a weak positive charge is conducted on the intermediate transfer member 7, the absolute value of the negative potential of the toner image is lowered.

The multi-colored toner image whose charge amount is made uniform by the charging unit 9 is second-transferred onto the transfer material P by the transfer roller 5AR, and the second transferred multi-colored toner image is fixed by the fixing apparatus 8.

The intermediate transfer member 7 after the second transfer, is cleaned by the intermediate transfer member cleaner means 6A.

In the transfer roller cleaning process, the control unit CR controls the charging unit 9, and the intermediate transfer member 7 is charged to the reverse polarity to the charge of the toner.

In the present embodiment using the negatively charged toner at the time of developing, the intermediate transfer member 7 is positively charged by the charging unit 9 in the transfer roller cleaning process. Therefore, the power source 91E applies the positive voltage on the charging electrode 91, and the power source 92E sets the voltage of the grid 91 to the positive potential. Hereby, the intermediate transfer member 7 is charged positively. Hereupon, to the transfer roller 5AR, the transfer voltage may be applied by the power source 5AE, in the same manner as in the image forming process, however, the transfer roller 5AR may be grounded. Hereupon, when the positive voltage is applied to the transfer roller 5AR, and the transfer roller cleaning process is conducted, it is charged so that the potential of the intermediate transfer member 7 is higher than that of the transfer roller 5AR. When the intermediate transfer member 7 is charged to the reverse polarity to the charge of toner, the toner adhered to the transfer roller 5AR is attracted by the electrostatic force and transferred onto the intermediate transfer member 7, and the transfer roller 5AR is cleaned. The toner transferred onto the intermediate transfer member 7 is scraped by the intermediate transfer member cleaner 6A, and the intermediate transfer member 7 is cleaned.

### THE SECOND EXAMPLE

The second example is the image forming apparatus of the structure shown in FIG. 1, and the control unit CR conducts the image forming process in the same manner as described in the first example, and conducts the transfer roller cleaning process, which will be described in the following.

In the transfer roller cleaning process, the control unit CR applies the voltage of the same polarity as the charge of toner to the transfer roller 5AR by the power source 5AE. In the present embodiment in which the negatively charged toner is used in the development, in the transfer roller cleansing process, the negative voltage is applied on the transfer roller 5AR. In conjunction with such a voltage application on the transfer roller, the control unit CR controls the charging unit 9, and discharges the intermediate transfer member 7.

That is, the control unit CR applies the AC voltage from the power source 91E to the charging electrode 91, and sets the grid 92 to the condition of floating.

In this manner, after the intermediate transfer member 7 is discharged and the surface potential of the intermediate transfer member 7 is made uniform, it is brought into contact with the transfer roller 5AR, and the voltage which is reverse to the case of image transfer, is applied on the transfer roller 5AR from the power source 5AE. In the present embodiment in which the negatively charged toner is used in the development, the negative voltage is applied on the transfer roller 5AR. Hereby, the toner adhered to the transfer roller 5AR is transferred to the intermediate transfer member 7, and the transfer roller 5A is cleaned.

The toner transferred to the intermediate transfer member 7 is removed from the intermediate transfer member 7 by the intermediate transfer member cleaner 6A, in the same manner as in the first embodiment.

### THE THIRD EXAMPLE

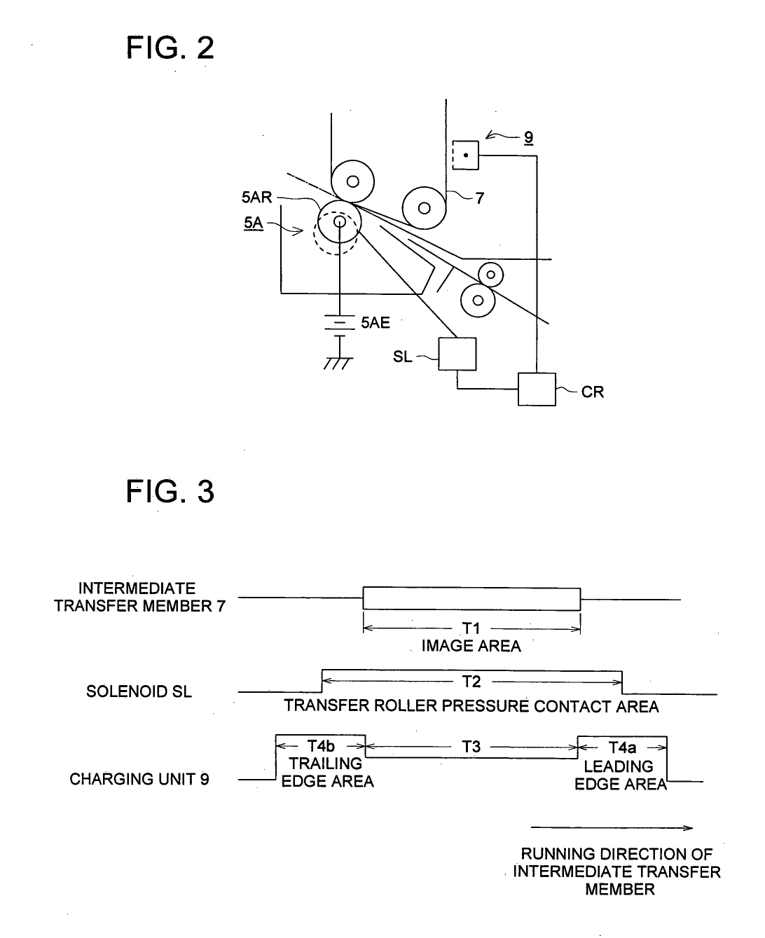

The image forming apparatus of the third example is the image forming apparatus of the structure shown in FIG. 1, and the main part has the structure shown in FIG. 2, and the control unit CR controls the charging unit 9 and a solenoid SL, in the manner as shown in FIG. 3 and as will be described in the following.

The solenoid SL brings the transfer roller 5AR into contract with the intermediate transfer member 7 and separates from it.

In FIG. 3, T1 is a time for passing the image area of the intermediate transfer member 7, that is, a time for which an area in which the intermediate transfer member 7 is brought into contact the transfer material P in the second transfer, passes a predetermined area, for example, the second transfer unit, T2 is a time for which the transfer roller 5AR is at a area shown by a solid line in FIG. 2, and in contact with the intermediate transfer member 7 trough the transfer material P or directly, and T3 is a time for which the charging means 9 adjusts the voltage on the intermediate transfer member 7 to the transfer appropriate value. In a time T4a corresponding to the leading edge area and a time T4b corresponding to the trailing edge area, the charging unit 9 charges the intermediate transfer member 7 and makes its potential to the reverse polarity to the charge of toner. The control is conducted so that (T3+T4a+T4b)≧T2≧T1 is satisfied. Hereupon, the control is conducted so that T1 is almost equal to T3, and T1 [symbol] T3.

By such a control, in the image area T1, the potential on the intermediate transfer member 7 is kept to an appropriate value, the transfer of the appropriate toner image is conducted, and in the leading edge and trailing edge of the transfer material P, in a area in which the intermediate transfer member 7 is brought into directly contact with the transfer roller 5AR, the intermediate transfer member 7 is charged to the potential attracting the toner, and it is blocked that the toner adhered to the intermediate transfer member 7 moves to the transfer roller 5AR, and a soil of the transfer roller 5AR is prevented.

### THE FOURTH EXAMPLE

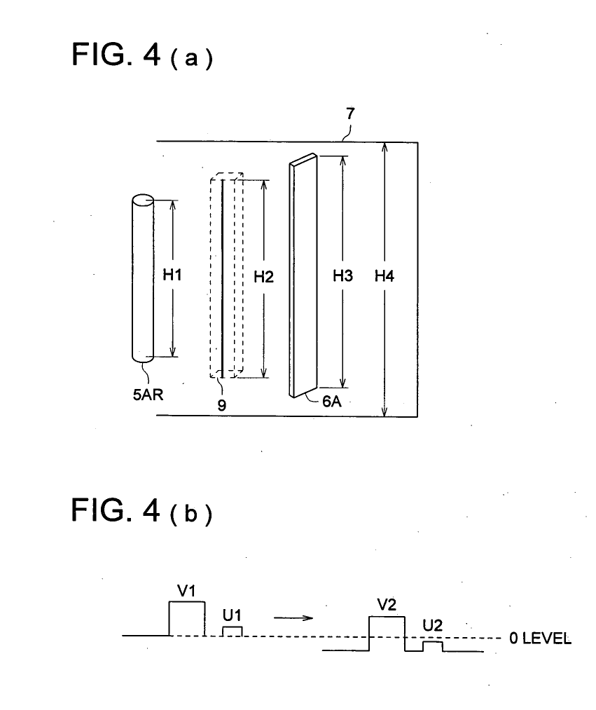

The image forming apparatus of the fourth example is the image forming apparatus of the structure shown in FIG. 1, and the main part has the structure shown in FIG. 4, and the control unit CR conducts the control which will be described in the following.

In FIG. 4, a sign H1 is the length of the transfer roller 5AR, in other words, it is a width in which the transfer roller 5AR is brought into contact with the intermediate transfer member 7, and a sign H2 is the length of the charging electrode 91 of the charging unit 9, that is, a charge width, and a sign H3 is a cleaning width of the intermediate transfer member cleaning member 6A, and a sign H4 is a width of the intermediate transfer member 7.

The transfer roller 5AR, charging unit 9, intermediate transfer member cleaner 6A and intermediate transfer member 7 are structured so that signs H1-H4 satisfy the following expression.
H1≦H2≦H3≦H4.

The control unit CR controls the charging unit 9 so that it lowers the potential of the toner image on the intermediate transfer member 7.

The charge of the intermediate transfer member 7 by the charging unit 9 is conducted in such a manner as shown in FIG. 4(b).

In FIG. 4(b), the charging unit 9 charges the intermediate transfer member 7 to a low positive potential. By this charge, the potential of toner image formed of the negatively charged toner is lowered from V1 to V2. Then, the potential of a small amount of toner adhered to the intermediate transfer member 7 in the non-image area, becomes from a low negative level of U1 to the potential of 0 or positive level. Then, in the second transfer, the negative charge toner forming the toner image is transferred onto the transfer material P by the positive transfer voltage, however, the toner charged to 0 or positive potential is not transferred, and held on the intermediate transfer member 7.

In this manner, a good transfer is conducted in the image area, and it is prevented that the toner is transferred onto the transfer roller 5AR in the non-image area.

By the above-described apparatus structure and control, the transfer of the toner image onto the intermediate transfer member is appropriately conducted, and in the non-image area in which the intermediate transfer member 7 is directly brought into contact with the transfer roller 5AR, it is blocked that the toner on the intermediate transfer member 7 is transferred to the transfer roller 5AR, and a soil of the transfer roller 5AR is prevented. Further, the reverse charge toner adhered to the intermediate transfer member 7 charged to the same polarity as the charge of toner, or paper powder is removed by the intermediate transfer member cleaning means 6A, and the entire surface of the intermediate transfer member 7 is finely cleaned.

### THE FIFTH EXAMPLE

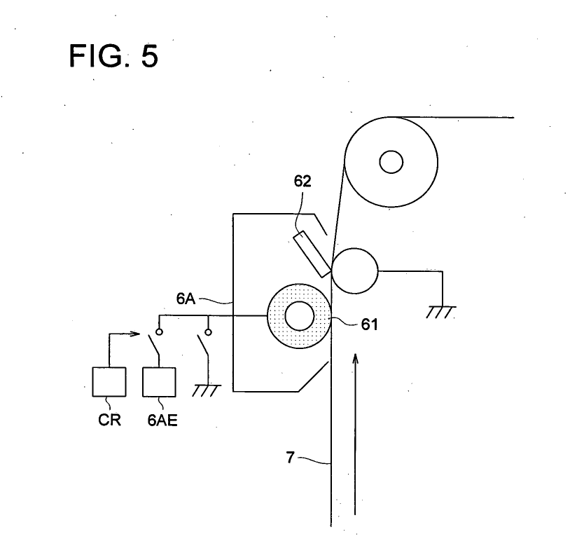

FIG. 5 shows a main part of the image forming apparatus according to the embodiment of the present invention.

The image forming apparatus shown in FIG. 5 uses a cleaning roller 61 on which the voltage is applied on the intermediate transfer member cleaner 6A. The cleaning roller 61 is a brush roller formed of the conductive fiber. In the image forming process, together with the cleaning by the cleaning blade 62, the positive voltage is applied on the cleaning roller 61 by the power source 6AE, the negatively charged toner is attracted to the cleansing roller 61, the toner is removed from the intermediate transfer member 7, and the intermediate transfer member 7 is cleaned.

In the cleaner cleaning process by which the toner adhered to the cleaning roller 61 is removed and the cleaning performance is recovered, the control unit CR causes the charging unit 9 to charge the intermediate transfer member 7 to the reverse polarity to the charge of toner. In the present embodiment using the negatively charged toner in the development, the intermediate transfer member 7 is positively charged. Further, the cleaning roller 61 is electrically grounded. Hereby, the toner adhered to the cleaning roller 61 is attracted to the intermediate transfer member 7, and the cleaning roller 61 is cleaned. The toner transferred to the intermediate transfer member 7 is scraped off by the cleaning blade 62, and removed from the intermediate transfer member 7. Hereupon, the toner transferred to the intermediate transfer member 7 can be removed from the intermediate transfer member 7 also by another method. For example, a method by which the toner on the intermediate transfer member 7 is transferred to the photoreceptors 1Y, 1M, 1C, 1K by the transfer rollers 5Y, 5M, 5C, 5K, can also be applied. In the cleaning process in which the toner on the intermediate transfer member 7 is transferred to the photoreceptors 1Y, 1M, 1C, 1K, the transfer rollers 5Y, 5M, 5C, 5K are set to floating. By this setting, the negatively charged toner is transferred from the positively charged intermediate transfer member 7 to the electrically grounded photoreceptors 1Y, 1M, 1C, 1K. The toner transferred to photoreceptors 1Y, 1M, 1C, 1K is removed by the cleaning means 6Y, 6M, 6C, 6K.

### THE SIXTH EXAMPLE

The image forming apparatus according to the sixth example has a structure shown in FIG. 1 and FIG. 5. In this example, the image forming process is conducted in the same manner as the fifth example.

In the cleaner cleaning process by which the toner adhered to the cleaning roller 61 is removed and the performance of the cleaning roller 61 is recovered, when the intermediate transfer member 7 is discharged by the charging unit 9, and the discharged intermediate transfer member 7 is passed the intermediate transfer member cleaner 6A, the toner is transferred from the cleaning roller 61 to the intermediate transfer member 7. When the voltage of the same polarity as the toner, that is, the negative voltage is applied on the cleaning roller 61 by the power source 6AE, the toner adhered to the cleaning roller 61 is transferred to the intermediate transfer member 7. The toner released on the intermediate transfer member 7 is removed from the intermediate transfer member 7 by the same method as the embodiment 5.

### EXPERIMENTAL EXAMPLE 1

### The Experimental Example of the First Example

By using the image forming apparatus shown in FIG. 1, the image forming process by which the image is formed on various sized sheets (transfer material) is conducted and images of ten-thousand sheets are formed. In this image forming process, as the operating conditions of the charging unit 9, the DC voltage of +5 kV is applied on the charging electrode 91 and the potential of the grid 92 is made −50 V.

In the image forming process of ten-thousand sheets, in the letter half part near ten-thousand, toner adhesion to the transfer roller 5AR is generated, and the rear surface soil, the density unevenness of the image by the poor transfer are generated.

After the image formation of ten-thousand sheets, DC +5 kV is applied on the charging electrode 91, the potential of the grid 92 is set to +200 V and the intermediate transfer member 7 is positively charged, the intermediate transfer member 7 is driven, and the toner on the transfer roller 5AR is collected on the intermediate transfer member 7. After the transfer roller 5AR is cleaned, when the image is formed, the rear surface soil or image unevenness is dissolved, and a fine image is formed.

### EXPERIMENTAL EXAMPLE 2

### The Experimental Example of the Second Example

By using the image forming apparatus shown in FIG. 1, the image forming process by which the image is formed on various sized sheets (transfer material) is conducted and images of ten-thousand sheets are formed. In this image forming process, as the operating conditions of the charging unit 9, the DC voltage of +5 kV is applied on the charging electrode 91 and the potential of the grid 92 is made −50 V.

In the image forming process of ten-thousand sheets, in the letter half part near ten-thousand, toner adhesion to the transfer roller 5AR is generated, and the rear surface soil, the density unevenness of the image by the poor transfer are generated.

After the image formation of ten-thousand sheets, the AC 4 kV (p-p voltage) is applied on the charging electrode 91, and the grid 92 is made floating, and the intermediate transfer member 7 is driven, and discharged.

Further, −3 kV is applied on the transfer roller 5AR by the power source 5AE, the toner on the transfer roller 5AR is transferred to the intermediate transfer member 7, and the transfer roller cleaning process by which the toner on the intermediate transfer member 7 is cleaned by the intermediate transfer member cleaner 6 is conducted.

After the cleaning of the transfer roller 5AR, as a result in which the image forming process is conducted, there is no generation of the rear surface soil or density unevenness of the image, and a good image is formed.

As a comparative example, after the ten-thousand sheets image formation is conducted, the discharging by the charging unit 9 is not conducted, that is, the charging unit 9 is made in off-condition, and −3 kV is applied on the transfer roller 5AR, and the transfer roller cleaning process is conducted.

In this comparative example, in the reopened image forming process, by a reason that the toner is remained on the transfer roller 5AR, the rear surface soil or density unevenness of the image is generated.

### EXPERIMENTAL EXAMPLE 3

### The Experimental Example of the Third Example

By using the image forming apparatus shown in FIG. 1, and the charging unit 9 is set in the manner that, in the image area, the charging electrode 91: DC+5 kV is applied, the grid potential: −50 V, and in the non-image area, the charging electrode: DC+5 kV is applied, the grid potential: +50 V, and the image transfer time (image area) T1, the transfer roller contact time T2, and the operation of the charging unit 9 are set as shown in FIG. 3, and the image formation of ten thousand sheets is conducted. As a result of that, there is no generation of the rear surface soil or the density unevenness of the image, the high quality image is formed.

### EXPERIMENTAL EXAMPLE 4

### The Experimental Example of the Fourth Example

The transfer roller 5AR, charging unit 9, intermediate transfer member cleaner 6A and intermediate transfer member 7 are made the structure as shown in FIG. 4(a), and the charging unit 9 is set in the manner that, the charging electrode 91: DC +5 kV is applied, the potential of the grid: electrical ground potential, and the image formation of ten thousand sheets is conducted.

As a result of that, there is no generation of the rear surface soil or the density unevenness of the image, and the high quality image is formed.

### EXPERIMENTAL EXAMPLE 5

### The Experimental Example of the Fifth Example

By using the image forming apparatus shown in FIG. 1, the image forming process by which the image is formed on various sized transfer materials (paper) is conducted and images of ten-thousand sheets are formed. In this image forming process, as the operating conditions of the charging unit 9, the DC voltage of +5 kV is applied on the charging electrode 91 and the potential of the grid 92 is made −50 V.

In the image forming process of ten thousand sheets, in the letter half part near ten thousand, the poor cleaning is generated.

After the image formation of ten thousand sheets, DC+5 kV is applied on the charging electrode 91, the potential of grid 92 is set to +200 V, and the intermediate transfer member 7 is driven, the toner adhered to the cleaning roller 61 is transferred to the intermediate transfer member 7, and the cleaner cleaning process to collect the toner by the cleaning blade 62 is conducted. Hereupon, in the image forming process and the cleaner cleaning process, 300 V is applied on the cleaning roller 6AR by the powwer source 6AE.

As a result that the image is formed after the cleaner cleaning process, there is no poor cleaning, and a good image is formed.

### EXPERIMENTAL EXAMPLE 6

### The Experimental Example of the Sixth Example

By using the image forming apparatus shown in FIG. 1, the image forming process by which the image is formed on various sized transfer materials (paper) is conducted and images of ten-thousand sheets are formed. In this image forming process, as the operating conditions of the charging unit 9, the DC voltage of +5 kV is applied on the charging electrode 91 and the potential of the grid 92 is made −50 V.

In the image forming process of ten thousand sheets, in the letter half part near ten thousand, the poor cleaning is generated.

After the image formation of ten-thousand sheets, the AC 4 kV (p-p voltage) is applied on the charging electrode 91, and the grid 92 is set to floating, and −300 V is applied on the cleaning roller 61 by the power source 6AE. The intermediate transfer member 7 is driven, and the toner adhered to the cleaning roller 61 is transferred on the intermediate transfer member 7, and the cleaner cleaning process to collect the toner by the cleaning blade 62, is conducted.

As a result that the image is formed after the cleaner cleaning process, there is no poor cleaning, and a good image is formed.

As the comparative example of this experimental example 6, the cleaner cleaning process by which, the discharge of the intermediate transfer member 7 by the charging unit 9 is not conducted, that is, the charging unit 9 is made off, and −300 V is applied on the cleaning roller 61 and intermediate transfer member is driven, is conducted.

As the result, in the comparative example, poor cleaning is generated.

In the above description, the following examples of the present invention are included.

(A) The image forming apparatus having the following: image bearing member; image forming unit to form the toner image on the image bearing member; intermediate transfer member; first transfer device to transfer the toner image on the intermediate transfer member onto the transfer material; second transfer device to transfer the toner image on the intermediate transfer member onto the transfer material; intermediate transfer member cleaner to clean the intermediate transfer member after the transfer; charging unit to give the electric charge to the intermediate transfer member; and control unit, by which, by controlling the charging unit, in the non-image area on the intermediate transfer member, the intermediate transfer member is charged to the reverse polarity to the charge of toner, and the toner adhered on the second transfer device is transferred to the intermediate transfer member.

(B) The image forming apparatus having the following: image bearing member; image forming unit to form the toner image on the image bearing member; intermediate transfer member; first transfer device to transfer the toner image on the image bearing member onto the intermediate transfer member; second transfer device to transfer the toner image on the intermediate transfer member onto the transfer material; intermediate transfer member cleaner to clean the intermediate transfer member after the transfer; charging unit to discharge the intermediate transfer member; and control unit to control the second transfer device and the charging unit, in the non-image area on the intermediate transfer member, so that the intermediate transfer member is discharged by the charging unit, and the inverse transfer by which the toner is transferred from the second transfer device to the discharged intermediate transfer member, is conducted.

(C) The image forming apparatus having the following: image bearing member; image forming unit to form the toner image on the image bearing member; intermediate transfer member; first transfer device to transfer the toner image on the image bearing member onto the intermediate transfer member; second transfer device which has the transfer roller which can be brought into contact with and separated from the intermediate transfer member, and transfers the toner image on the intermediate transfer member onto the transfer material; intermediate transfer member cleaner to clean the intermediate transfer member after the transfer; charging unit to give the electric charge to the intermediate transfer member; and control unit which timing-controls the charging unit, so that the charging unit charges the intermediate transfer member to the reverse polarity to the charge of toner, to the leading edge area which adjoins the leading edge part of the image area, and includes the area at which the transfer roller is brought into contact with the intermediate transfer member, and the trailing edge area which adjoins the trailing edge part of the image area and includes the area at which the transfer roller is brought into contact with the intermediate transfer member.

(D) The image forming apparatus having the following: image bearing member; image forming unit to form the toner image on the image bearing member; intermediate transfer member; first transfer device to transfer the toner image on the image bearing member onto the intermediate transfer member; second transfer device which has the transfer roller, and transfers the toner image on the intermediate transfer member onto the transfer material; intermediate transfer member cleaner to clean the intermediate transfer member after the transfer; and charging unit to give the electric charge to the intermediate transfer member; wherein, when the cleaning width of the intermediate transfer member is H3, charging width of the charging unit is H2, and length of the transfer roller is H1, then, H1≦H2≦H3 is satisfied.

(E) The image forming apparatus having the following: image bearing member; image forming unit to form the toner image on the image bearing member; intermediate transfer member; first transfer device to transfer the toner image on the image bearing member onto the intermediate transfer member; second transfer device to transfer the toner image on the intermediate transfer member onto the transfer material; intermediate transfer member cleaner to clean the intermediate transfer member after the transfer; charging unit to give the electric charge to the intermediate transfer member; and control unit to control the charging unit so that, in the non-image area, when the charging unit charges the intermediate transfer member to the reverse polarity to the charge of toner, the toner adhered to the intermediate transfer member cleaner is moved to the intermediate transfer member.

(F) The image forming apparatus having the following: image bearing member; image forming unit to form the toner image on the image bearing member; intermediate transfer member; first transfer device to transfer the toner image on the image bearing member onto the intermediate transfer member; second transfer device to transfer the toner image on the intermediate transfer member onto the transfer material; intermediate transfer member cleaner having the cleaning member and the power source to apply the voltage on the cleaning member, and to clean the intermediate transfer member after the transfer; charging unit to give the electric charge to the intermediate transfer member; and control unit to control the charging unit so that the charging unit discharges the intermediate transfer member, and to control the power source so that the toner is transferred from the cleaning member onto the discharged intermediate transfer member.

The point in which various effects are attained by the examples (A)-(F) of the present invention, is clear. For example, in examples (A)-(D), because the charged condition of the surface of the intermediate transfer member is made uniform, and the inverse transfer to transfer the toner from the second transfer device onto the intermediate transfer member, is conducted, there is no case where the electric field of the inverse transfer is not uniform depending on a position on the intermediate transfer member, and the uniform inverse transfer is conducted, and the cleaning of the second transfer device is finely conducted.

Further, when the structure by which the charge of the intermediate transfer member is conducted just before the second transfer device, is adopted, the transfer of the toner onto the intermediate transfer member by the inverse transfer is reliable, and the cleaning effect of the second transfer device is improved.

In the examples (C), (D), the transfer material does not exist between devices in the second transfer, and in the non-image area in which the intermediate transfer member is directly brought into contact with the second transfer device, it is prevented that the toner adhered to the intermediate transfer member is transferred to the second transfer device, and in the non-image area, the phenomenon such as the image soil by the toner adhered to the second transfer device, the rear surface soil, is prevented.

In examples (E), (F), a phenomenon that the toner is accumulated on the intermediate transfer member cleaner and the cleaning performance is lowered is prevented, and the high cleaning performance is maintained for a long period of time.

Because a processing that the toner is transferred from the intermediate transfer member cleaner to the intermediate transfer member, is conducted on the intermediate transfer member whose charged condition of the surface is regulated and the intermediate transfer member cleaner, there is no transfer unevenness depending on the position, and the toner can be almost perfectly removed from the intermediate transfer member cleaner.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. An image forming apparatus comprising:
an image bearing member;
an image forming unit for forming a toner image on the image bearing member;
an intermediate transfer member;
a first transfer device for transferring the toner image on the image bearing member onto the intermediate transfer member;
a second transfer device for transferring the toner image on the intermediate transfer member onto a transfer material;
an intermediate transfer member cleaner for cleaning the intermediate transfer member after the transfer;
a charging unit for giving the electric charge to the intermediate transfer member; and
a control unit by which, when the charging unit is controlled, in non-image area on the intermediate transfer member, the intermediate transfer member is charged to the reverse polarity to the charge of toner, and the toner adhered to the second transfer device is transferred to the intermediate transfer member.

2. The image forming apparatus of claim 1, wherein the second transfer device includes a transfer roller and a power source for applying the transfer voltage on the transfer roller.

3. The image forming apparatus of claim 1, wherein the charging unit is arranged between the first transfer device and the second transfer device.

4. The image forming apparatus of claim 1, wherein the charging unit includes a charging electrode and a scorotron charger having a grid, and the control unit controls the charging unit in such a manner that, in the image area on the intermediate transfer member, the charging unit applies the voltage of the reverse polarity to the charge of toner onto the charging electrode, the intermediate transfer member is charged by the charging unit whose grid is set to the potential of the same polarity as the charge of toner, the toner image is transferred from the intermediate transfer member onto the transfer material, and in the non-image area on the intermediate transfer member, the voltage of the reverse polarity to the charge of toner is applied onto the charging electrode, the intermediate transfer member is charged by the charging unit whose grid is set to the potential of the reverse polarity to the charge of toner, and the toner on the second transfer device is transferred to the intermediate transfer member.

5. An image forming apparatus comprising:
an image bearing member;
an image forming unit for forming the toner image on the image bearing member;
an intermediate transfer member;
a first transfer device for transferring the toner image on the image bearing member onto the intermediate transfer member;
a second transfer device for transferring the toner image on the intermediate transfer member onto a transfer material;
an intermediate transfer member cleaner for cleaning the intermediate transfer member after the transfer;
a charging unit for discharging the intermediate transfer member; and
a control unit for controlling the second transfer device and the charging unit so that, in the non-image area on the intermediate transfer member, the intermediate transfer member is discharged by the charging unit, and the inverse transfer by which the toner is transferred from the second transfer device to the discharged intermediate transfer member, is conducted.

6. The image forming apparatus of claim 5, wherein the second transfer device includes the transfer roller, and the power source for applying the voltage on the transfer roller, and the control unit, by controlling the power source, conducts the transfer of the toner image onto the transfer material and the inverse transfer of the toner onto the intermediate transfer member.

7. The image forming apparatus of claim 5, wherein the charging unit is arranged between the first transfer device and the second transfer device.

8. The image forming apparatus of claim 5, wherein the charging unit charges the intermediate transfer member in the image area of the intermediate transfer member, and the control unit changes the operation condition of the charging unit in the image area and in the non-image area.

9. An image forming apparatus comprising:
an image bearing member;
an image forming unit for forming the toner image on the image bearing member;
an intermediate transfer member;
a first transfer unit for transferring the toner image on the image bearing member onto the intermediate transfer member;
a second transfer unit having a transfer roller which can be brought into contact with and separated from the intermediate transfer member, and for transferring the toner image on the intermediate transfer member onto a transfer material;
an intermediate transfer member cleaner for cleaning the intermediate transfer member after the transfer;
a charging unit for applying an electric charge to the intermediate transfer member; and
a control unit for timing-controlling the charging unit so that the charging unit charges the intermediate transfer member to the reverse polarity to the charge of toner, to the leading edge area, which adjoins the leading edge part of the image area, and includes an area in which the transfer roller is brought into contact with the intermediate transfer member, and to the trailing edge area, which adjoins the trailing edge part of the image area, and includes an area in which the transfer roller is brought into contact with the intermediate transfer member.

10. The image forming apparatus of claim 9, wherein the charging unit includes a scorotron charger having a charging electrode and a grid, and the control unit applies the voltage of the reverse polarity to the charge of toner onto the charging electrode, and when the grid is set to the potential of the reverse polarity to the charge of toner, charges the intermediate transfer member in the leading edge area and the trailing edge area.

11. An image forming apparatus comprising:
an image bearing member;
an image forming unit for forming the toner image on the image bearing member;
an intermediate transfer member;
a first transfer device for transferring the toner image on the image bearing member onto the intermediate transfer member;
a second transfer device having a transfer roller, and for transferring the toner image on the intermediate transfer member onto a transfer material;
an intermediate transfer member cleaner for cleaning the intermediate transfer member after the transfer; and
a charging unit for applying an electric charge to the intermediate transfer member, wherein, when the cleaning width of the intermediate transfer member is H3, the charging width of the charging unit is H2, and the length of the transfer roller is H1, then, H1≦H2≦H3 is satisfied.

12. The image forming apparatus of claim 11, wherein the charging unit charges the intermediate transfer member so that the absolute value of the potential of the toner image on the intermediate transfer member is lowered.

13. The image forming apparatus of claim 12, wherein the intermediate transfer member cleaner has a cleaning roller.

14. An image forming apparatus comprising:
an image bearing member;
an image forming unit for forming the toner image on the image bearing member;
an intermediate transfer member;
a first transfer device for transferring the toner image on the image bearing member onto the intermediate transfer member;
a second transfer device for transferring the toner image on the intermediate transfer member onto a transfer material;
an intermediate transfer member cleaner for cleaning the intermediate transfer member after the transfer;
a charging unit for applying an electric charge to the intermediate transfer member; and
a control unit for controlling the charging unit, in the non-image area, when the charging unit charges the intermediate transfer member to the reverse polarity to the charge of toner, so that the toner adhered to the intermediate transfer member cleaner is moved to the intermediate transfer member.

15. The image forming apparatus of claim 14, wherein the intermediate transfer member cleaner has a cleaning roller which is electrically grounded or on which the voltage is applied.

16. The image forming apparatus of claim 14, wherein the control unit changes the operation condition of the charging unit in the image area and in the non-image area.

17. An image forming apparatus comprising:
an image bearing member;
an image forming unit for forming the toner image on the image bearing member;
an intermediate transfer member;
a first transfer unit for transferring the toner image on the image bearing member onto the intermediate transfer member;
a second transfer unit for transferring the toner image on the intermediate transfer member onto a transfer material;
an intermediate transfer member cleaner having a cleaning member and the power source to apply the voltage on the cleaning member, and for cleaning the intermediate transfer member after the transfer;
a charging unit for applying an electric charge to the intermediate transfer member; and
a control unit for controlling the charging unit so that the charging unit discharges the intermediate transfer member, and for controlling the power source so that the toner is transferred from the cleaning member onto the discharged intermediate transfer member.

18. The image forming apparatus of claim 17, wherein the control unit changes the operation condition of the charging unit in the image area and in the non-image area.
